(19) United States
(12) Patent Application Publication
(10) Pub. No.: US 2002/0170818 A1
(43) Pub. Date: Nov. 21, 2002

(54) Method and apparatus for producing liquid fuel

(76) Inventor: Randall J. Miranda, Tarpon Springs, FL (US)

Correspondence Address: Stephaen A. Pendorf, Pendorf & Cutliff, P.O. Box 20445, Tampa, FL, 33622-0445, US

(21) Appl. No.: 09/861,804

(22) Filed: May 21, 2001

(51) Int. Cl. C10L 1/00; C01B 31/00; B01J 7/00

(52) U.S. Cl. 204/173; 44/300; 204/242; 204/274; 48/61

(57) ABSTRACT

A method of converting graphite from solid state to a gaseous state and further processing the gas to produce liquid fuel. The gasification of the graphite is achieved by using electrolysis under seawater.

### BACKGROUND OF THE INVENTION

1. Field of the Invention

The present invention concerns the generation of gas, and more particularly, this invention relates to a method and apparatus for converting graphite into liquid fuel that can be used as heating oil, gasoline or diesel substitute.

2. Discussion of the Related Art

As time passes, energy consumption has continued to increase throughout the world as a result of the population explosion, accelerated industrialization, economic growth, and social development.

There is an increased public awareness of the social and environmental problems related to the provision and consumption of fuels. Efficiency in the provision of fuel is one of the more critically important technical problems of the day. At the very time that the world's economy and the economies of the industrialized countries are becoming increasingly dependent on the consumption of fuel, there is a growing realization that the main sources of this fuel, the earth's non-renewable fossil fuel reserves, will inevitably be exhausted, and that in any event, the natural environment of the earth cannot readily assimilate the by-products of fossil fuel at much higher rates than it does at present without suffering unacceptable levels of pollution.

The production of liquid fuel is becoming quite desirable since liquid fuel has beneficial aspects as a direct heating fuel or as a means for generating electrical energy. Consequently, substantial efforts have been devoted to obtaining large volumes of liquid fuel for subsequent use as heating oil, gasoline or diesel substitute.

The production of liquid fuel has been known since the days of Van Helmont (d. 1644). The prior art produces liquid fuel by destructive distillation of carbonaceous product. Commercial development and public demonstration of production of liquid fuel for heat and light came from the work of Phillipe Lebon (1767-1804) in France. Lebon publicly demonstrated gas lighting in 1801, using gas obtained from the destructive distillation of carbonaceous products.

A disadvantage presented by the prior art is that the destructive distillation of the carbonaceous products requires high temperatures to break the carbon long chains into small chains in order to obtain a gaseous form. Another disadvantage of the prior art is that the carbonaceous products contain other elements other than carbon such as nitrogen and sulfide. Thus, the processes of the prior art produce contaminant gases such as carbon monoxide, carbon dioxide, hydrogen gases, nitrogen, hydrogen sulfide, and COS gases. The presence of such undesirable contaminant gases usually requires the use of subsequent cleaning and conversion steps to either separate or filter out the undesired gases.

The prior art also presents a paper entitled, “On the Electrolysis of Coal Slurries,” authored by Messrs. G. Okada, V. Guruswany, and J. Brockris of the Department of Chemistry, Texas A & M University, and published in the Journal of the Electrochemical Society, Vol. 128, No. 10, October 1981, and describes the results of experiments which establish the feasibility of electrolyzing coal slurries to produce essentially pure CO₂ and H₂.

In the tests reported in that paper, a simple electrolysis cell utilizing two electrodes immersed in a coal slurry and electrolyte mixture was used to achieve a successful electrolysis of coal.

Although the operability of such electrolysis reactions are of interest in studying alternative carbonaceous products gasification processes, it is apparent that in order to adapt their teachings for possible use in suitably high volume commercial gasification process apparatus, some additional means would be necessary for suitably protecting the electrodes from becoming quickly poisoned or blocked by evolved gases.

Also, the electrolysis of coal requires supplying a high amount of electricity to the electrodes in order to break the long chain of carbon of the coal into a small chain to produce the gas. Also, coal contains elements other than carbon, such as nitrogen and sulfide, and these elements will produce contaminant gases such as carbon monoxide, carbon dioxide, hydrogen gases, nitrogen, hydrogen sulfide, and COS gases. The presence of such undesirable contaminant gases usually requires the use of subsequent cleaning and conversion steps to either separate or filter out the undesired gases.

The present inventor felt a need for a simplified, economical, reliable, non-air-polluting, and easy-to-use process and apparatus for producing liquid fuel.

### SUMMARY OF THE INVENTION

Therefore, the main object of the present invention is to provide a method and apparatus for pure carbon graphite gasification of such high efficiency, which heretofore has not been possible.

It is yet another object of the invention to provide a non-air-polluting method for generating liquid fuel, using graphite as the source of energy.

It is yet another object of this invention to provide a method and apparatus for the gasification of graphite using the principle of electrolysis to generate enough power to furnish the power requirements of the electrolysis process and also for making available electric power to the open market.

It is yet another object of the instant invention to provide a method and apparatus for the gasification of carbon using the principle of electrolysis which require a relatively small investment.

It is yet another object of the instant invention to provide a method and apparatus for the gasification of carbon using the principle of electrolysis, which results in a dependable system, that is easily maintained.

In view of the foregoing disadvantages inherent in the known processes of carbon gasification, the present inventor discovered a method and apparatus which even though it requires high temperatures, the use of subsequent cleaning and conversion steps to either separate or filter out the undesired gases, or high consumption of electrical energy, will not be necessary.

Generally stated, the present invention includes a method of converting graphite from solid state to a gaseous state and further processing the gas to produce liquid fuel. The gasification of the graphite is achieved by using electrolysis. A direct voltage potential is applied underwater (seawater) to the graphite inside an electrolysis tank. The spark produced during the electrolysis generated enough heat to boil the water out of the seawater. Also during the electrolysis, the water breaks into its chemical compounds that are hydrogen & oxygen.

Although the exact mechanism by which the liquid fuel is produced is not understood, it is believed that these two gases rise to the top of the tank, and merge with the carbon gas that was generated by the graphite; the combination of these three gases, will generate the desired gas.

To produce the liquid fuel, a portion of the gas generated by the electrolysis process will be pumped via a compressor into a heat exchanger unit that will reduce the temperature of the gas. The pressure of the cooled gas is reduced by passing the gas over to two expansion engines that will drastically reduce the temperature of the gas to a chill. The temperature-reducing step is vital to the conversion of the gas into the liquid state.

When the gas exits the expansion engines, it will be pumped into a conversion tank that will have an expansion valve that will transform the chilled gas into a liquid form gas.

The liquid fuel is then pumped into big storage tanks that will hold the product until it is pumped again into trucks or shipped.

Another portion of the gas generated by the electrolysis process will be pumped via a compressor into a holding tank that will be used to feed a gas-burning turbine. This turbine will spin and turn the generator that will produce the electrical power needed to maintain the system going all the time as well as supply all the electricity needed to maintain even a small town.

The process also generates distilled water as a by-product. The boiling of the seawater generates a steam that will be collected in a separate unit within the apparatus and will be processed through a distiller in order to generate distilled water.

The process will also generate salt as a by-product. When the seawater is evaporated, the salt will be left behind and will be passed through various salt ion collectors on the salt collection stage of the apparatus in order to remove the salt from the system.

A more complete understanding of the present invention will be afforded to those skilled in the art from a consideration of the following detailed description of the present invention.

The foregoing has outlined rather broadly the more pertinent and important features of the present invention in order that the detailed description of the invention that follows may be better understood, and so that the present contribution to the art can be more fully appreciated. Additional features of the invention will be described hereinafter, which form the subject of the claims of the invention. It should be appreciated by those skilled in the art that the conception, method, and apparatus disclosed may be readily utilized as a basis for modifying or designing other electrolysis systems for carrying out the same purposes of the present invention. It should also be realized by those skilled in the art that such equivalent structures do not depart from the spirit and scope of the invention as set forth in the appended claims.

Before explaining in detail the present invention, it is to be understood that the invention is not limited to the details of construction and the arrangement of the parts illustrated on the accompanying drawings since the invention is capable of other embodiments. Also, it is to be understood that the phraseology or terminology herein is for the purpose of description and not limitation.

### DESCRIPTION OF THE FIGURES

Other objects, features, and advantages of the present invention will be apparent from the written description and the drawings in which:

FIG. 1 is a schematic diagram of the present invention.

FIG. 2 is a schematic diagram showing in more detail the operation of the electrolysis tank of the present invention.

FIG. 3 is a schematic diagram showing in more detail the operation of the salt-water separation section of the present invention.

FIG. 4 is a schematic diagram showing in more detail the operation of the water distillation system of the present invention.

FIG. 5 is a schematic diagram showing in more detail the operation of the power generating section of the present invention.

FIG. 6 is a schematic diagram showing in more detail the operation of the Liquid fuel conversion section of the present invention.

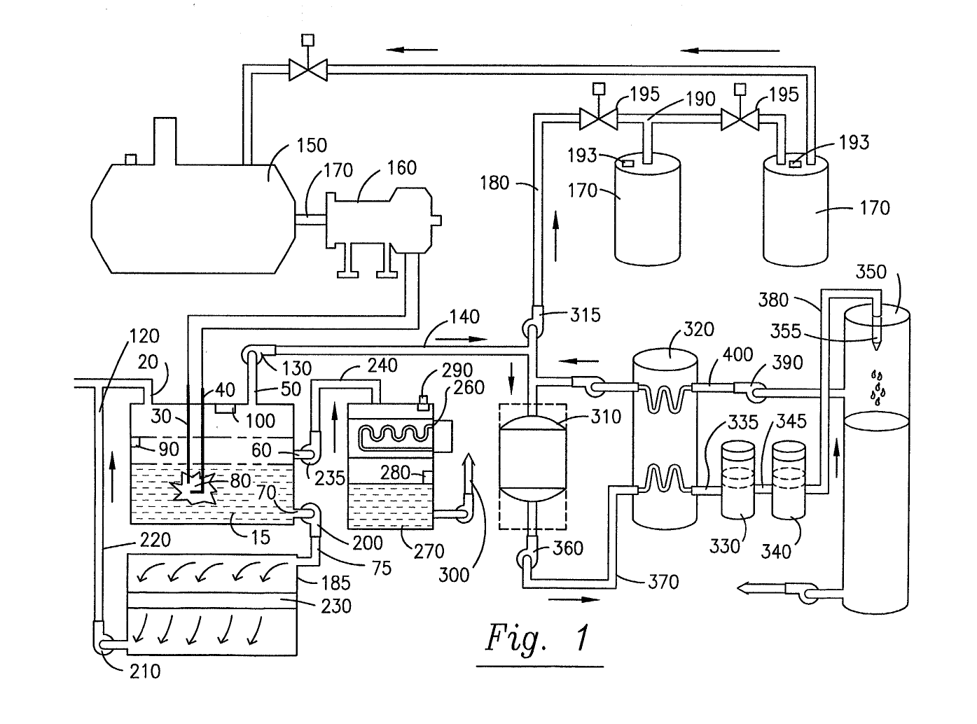

### DETAILED DESCRIPTION OF THE INVENTION

The present inventor surprisingly discovered that liquid fuel can be produced by the electrolysis of graphite under water, and that process does not require high-energy consumption or produced contaminants.

The graphite contains pure carbon and in order to transform the carbon into the gaseous form, the energy needed is minimal compared with the energy needed if a carbonaceous product (long chains carbon) is used. Thus, a great amount of saving could be achieved.

Another advantage of the present invention is that because graphite, pure carbon, is used, the present invention avoids the presence of contaminants such as nitrogen and sulfur that produce contaminants such as oxides of nitrogen and sulfur common in the gasification of carbonaceous products.

Other advantages include the fact that water and carbon are relatively low-cost inputs. Similarly, the power required to decompose seawater is readily available at reasonable cost in at least most locations.

### Electrolysis Tank

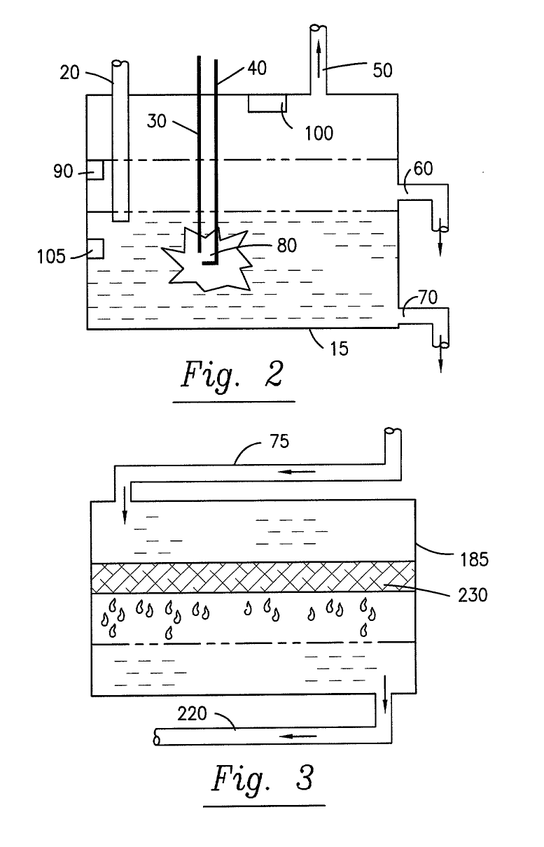

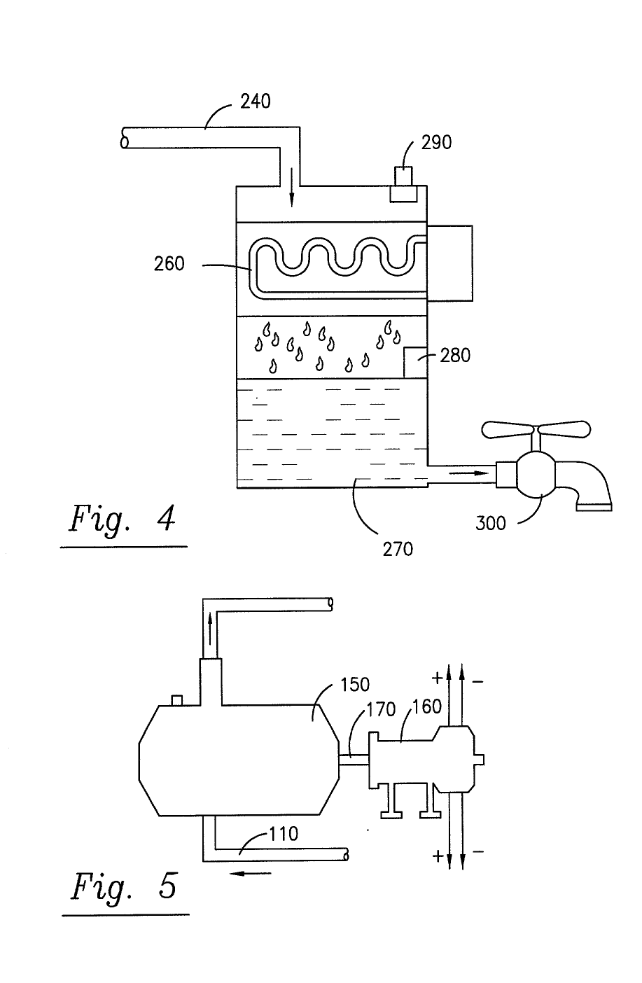

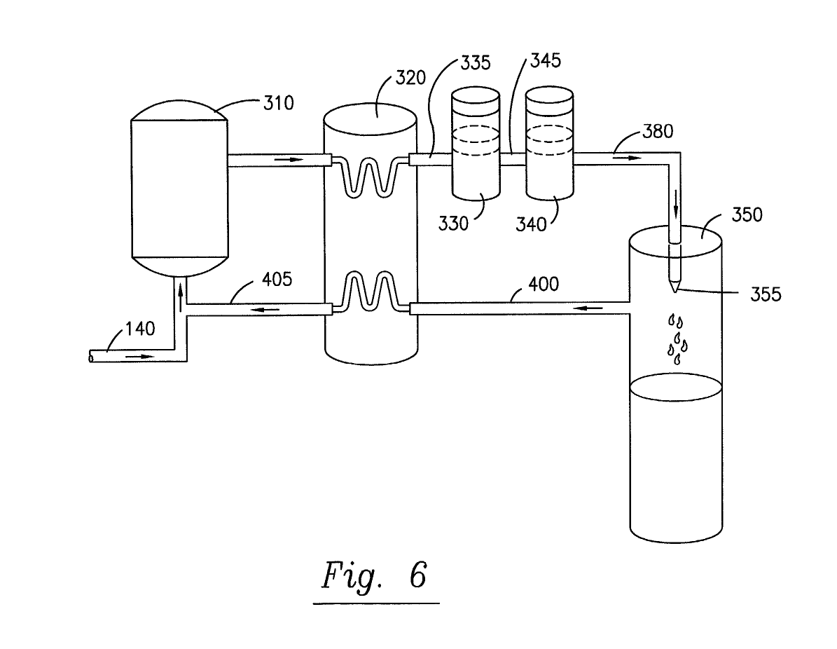

FIG. 2 shows the electrolysis tank. The electrolysis tank 10 includes a reservoir 15, salt-water input 20, a cathode 30, an anode 40, a gas output 50, a water vapor output 60, and a salt output 70.

The invention uses graphite bars between 18 inches to 6 feet long and ½ inch to 6 feet wide, such as the one supplied by SGL Carbon Group.

The cathode and anode are separated at a distance between 1/132 to ⅛ of an inch, preferably 1/16 of an inch.

The electrolysis tank 10 will take graphite and transform it into a gas underwater. A direct voltage potential of between 50 and 500 volts, preferably 80 to 300 volts, most preferably 240 volts, is applied constantly to the graphite in order to produce a spark 80 that causes the graphite to transform into gas form. The amount of voltage applied to the system depends on the size of the graphite bars.

The electrolysis process is conducted underwater, in this case seawater, thus the reaction tank is made up of non-corrosive materials such as stainless steel or an acid-resistant plastic to resist erosion and the attack from corrosive. The tank is preferably grounded.

The seawater used in the process of this invention is not subject to any unusual requirement.

The heat generated by the spark produces the water present in the seawater to boil and transform into steam. Also, during the electrolysis, the water discomposes into its chemical compounds hydrogen & oxygen.

These two gases will rise to the top of the tank, and they will merge with the gas that was generated by the graphite. The combination of these three gases generates the desired gas.

The gas produced by this process is a flammable gas, but is not a self-combusting gas like propane or methane, because it needs about 10% oxygen addition in order to combust.

Since it will not combust on its own unless mixed with at least 10% oxygen, and at the same time exposed to an open flame or spark, it is very safe to transport as well as to store in tanks without the danger of explosion.

This property makes it perfect for replacing acetylene, natural and propane gas, especially since it does not leave any residue behind inside the tank as is customary by acetylene and propane gases.

The use of this gas will eliminate the problem of deaths related to gas leaking since this gas is not poisonous.

The electrolysis tank 10 will also include an automatic rod feeder (not shown). The automatic rod feeder, which holds and dispenses the carbon rods, is conveniently made of metal, plastic, or ceramic. The automatic feeder may accommodate any convenient number of rods, conveniently loaded upright side-by-side on an inside surface slanting down to an exit directly above the desired electrode-bridging location. The feeder will allow the system to run for 1 month without human intervention.

The tank will also have a conventional water level safety switch 90 to protect the system from overflow.

In addition, the tank will have a conventional safety release valve 100 to protect the system from exploding due to failure of the suction pumps that extract the gas from the electrolysis tank and feed it to the power generating section 110. The system also contains an emergency shut off switch 105.

The electrolysis tank 10 will also include a feedback water entry 120 that will come from the salt filtration system that will feed seawater back into the electrolysis tank after removing all the excess salt brine that was generated at the tank earlier.

### The Conversion Section

A portion of the gas generated by the electrolysis tank will be pumped via a gas pump 130 through conduit 140 into an air compressor 310. The compressor will increase the gas pressure and, at the same time, will increase the temperature of the gas as well.

From the compressor, the gas is pumped via a gas pump 360 through conduit 370 into a heat exchanger unit 320 that will reduce the temperature of the gas. The pressure of the cooled gas is reduced by passing the cooled gas over two expansion engines 330, 340 that will drastically reduce the temperature of the gas to a chill. The temperature-reducing step is vital for the conversion of the gas to the liquid state.

The expansion is done in two stages to prevent evaporation in the expansion engine and to allow more flexible operation.

The output of the heat exchanger 320 passes to the first expansion engine 330 via the conduit 355. The output of the first expansion engine 330 passes to the second expansion engine 340 via the conduit 345.

The expanded gas from the expansion engines is introduced through conduit 380 provided with an inlet device into the upper part of a conversion tank 350.

The conversion tank 350 will have an expansion valve 355 that will transform the gas into a liquid form. The gas that does not turn into liquid state the first time will be pumped back by a pump 390 via a line 400 into the gas converting system after it is passed again through the heat exchanger unit to warm the gas before it is fed directly via conduit 405 into the main compressor so it will be reprocessed again.

This procedure will repeat over and over until all gas is converted into liquid form. The liquid fuel is then pumped into big storage tanks that will hold the product until it is pumped again into trucks or shipped.

This final liquid fuel will be able to be used in cars, trucks, boats, etc. in substitution of the regular gasoline, diesel fuel, etc.

### The Power Generating Stage

A portion of the gas generated by the electrolysis tank will be pumped via a compressor 315 into storage tanks that will be used to feed a gas-burning turbine 150. The gas is pumped by a gas pump through conduit 180 into the storage tanks 170. The turbine 150 powers an AC/DC generator 160, which is suitable for generating electrical power by techniques, which are well known to those skilled in the art.

The gas turbine 150 is a conventional gas turbine, which normally includes a combustion chamber wherein liquid fuel is reacted with combustion air. The gas turbine is used as a driving force for operating an electrical power-producing generator 160. The operation of gas turbine substantially reduces the temperature and pressure of the storage tanks 170.

The generator 160 will produce all the electrical (120 VAC, 240 VAC & 120 VDC) power needed to maintain the system operating all the time, as well as supply extra power for other applications, including its sale in the open market.

The gas produced by the electrolysis is accumulated in at least one storage tank, but it should be expressly understood that a plurality of storage tanks can be utilized in the process of the present invention; the number of storage tanks used and the size of these tanks will depend in part on the quantity of gas to be stored.

In those cases where more than one storage tank is utilized, it is desirable to introduce the gas into the storage tanks, one tank at a time, until all of the tanks are charged with the appropriate amount of gas. Among the techniques by which this can be achieved is to provide line 180 as the source of gas for each storage tank and to position valves 190 for each storage tank employed. Hence, when more than one storage tank is utilized, each storage tank will have associated with it a valve 193 to control the flow of gas from line 180. The line 180 is provided with escape release valves 195 to control the line pressure.

### The Salt Separation System

Salt is generated as a by-product of the electrolysis tank 10. When the water is evaporated from the seawater in the electrolysis tank 10, the excess of salt left behind will be pumped by a pump 200 through a line 75 into a salt ion collector 230 on the salt collection stage of the apparatus in order to remove the salt from the system.

The excess of water in the salt collection stage is pumped by a water pump 210 through a line 220 back into the electrolysis tank 10. The sodium chloride crystals are separated from the cooled brine by means such as settling, centrifugation, and filtration. The separated crystals can be recovered as is, or can be washed with a portion of cool distillate water at a minimum contact time to enhance their purity.

### Water Distillation Section

Boiling the water out of the seawater will generate steam that will be collected in a separate unit within the apparatus and will be processed through a distiller in order to generate distilled water.

The steam generated in the electrolysis tank will be pumped by a gas pump 235 through a line 240 into the distiller's tank 250.

Once the steam is pumped in the distiller, the unit will condense the steam in the primary chamber of the distiller. The distiller uses a chemical coolant coil 260 to cool off the steam pumped into the distiller 250. When the steam is cooled, it will turn into distilled water that will be collected in the second section of the distiller that will be a holding tank 270.

From the holding tank, the distilled water will be pumped out of the apparatus by means of an internal water pump that will supply an outside faucet 300 to be used by the user.

The holding tank will have a safety water level switch 280 that when the water level of the tank has reached its maximum height, will cut off the cooling system, and the steam that is pumped into the water distiller will escape via an emergency steam release valve 290.

### Heating & Air Conditioning System (optional)

The exhaust from the turbine can be connected to a heating and air conditioner system (not shown). The exhaust from the turbine is passed through a water tank. The exhaust pipe inside the tank is shaped as a serpentine and covers the entire water tank. The tank works as a heat exchanger because the heat from the exhaust pipe is transferred into the water. Some of the water will turn into a steam.

The hot water is used in another section called the water chiller where the water will be chilled and passed through a serpentine coil that will have a fan blowing into it causing the air that comes out to be chilled and capable of being used as an air conditioner.

The steam portion of the water generated from the heat exchanger is fed into a steam-hot water separator, were the steam is separated from the hot water and used to feed the heating system section of the unit. At this stage, the steam will be broken down into hot air for heating the building and hot water for laundering.

Part of the steam generated at the steam-hot water separator unit is fed into the water chiller section of the system in order to maintain a difference in temperature in the chiller section of the system and allow the chemical coolant coil to operate and chill the water as a result.

The steam-hot water separator stage will also generate some hot water that will be fed into the water chiller as well as returned back into the heat exchanger section.

From the foregoing detailed description of the disclosure, it is evident that the instant invention is novel and is a contribution of great significance to the art of gasification, to the production of energy, to the control of emission, to the elimination of health hazards to the workers, to the improvement of the balance of payments, to the employment of an abundant domestic energy source (carbon), and to the conservation of capital. All in all, it is submitted that the present invention provides a new and useful method and apparatus for the making of gas from carbon efficiently in order to make available clean and abundant energy on which our country depends.

This method should not be understood as violating any accepted scientific principle, but only as applying science to economic advantage, as facilitated by the negative voltage coefficient of electric arcs.

Preferred embodiments and variants have been suggested for this invention. Other modifications may be made, as by adding, combining, deleting, or subdividing compositions, parts, or steps, while retaining all or some of the advantages and benefits of the present invention which itself is defined in the following claims.

What I claim is:

1. A method of converting graphite to a gas by an electrolysis process, the method comprising the steps of:
(a) providing an electrolysis tank having a reservoir, a top, a bottom, a cathode, and an anode;
(b) introducing graphite into the reservoir;
(c) introducing seawater to the electrolysis tank; and
(d) applying a direct voltage potential to the graphite inside the electrolysis tank;
wherein the electrolysis process is conducted underwater;
wherein the direct voltage produces a spark that causes the graphite to transform into carbon gas;
wherein the heat generated by the spark produces the water to boil and discomposes into hydrogen and oxygen;
wherein the hydrogen and the oxygen rise to the top of the tank and merge with the carbon gas to produce the gas.

2. A method according to claim 1, wherein the direct voltage applied is between 50 and 500 volts.

3. A method according to claim 1, wherein the direct voltage applied is 240 volts.

4. A method for producing liquid fuel used as fuel, the method comprising the steps of:
(a) converting graphite into gas by an electrolysis process under seawater;
(b) introducing the gas from the electrolysis process into an air compressor, wherein the air compressor increases the temperature and pressure of the gas;
(c) introducing the gas from the air compressor into a heat exchanger unit to reduce the temperature of the gas;
(d) introducing the gas from the heat exchanger into at least one expansion engine; wherein the expansion engine drastically reduces the temperature of the gas and produces a chilled gas; and
(f) introducing the chilled gas into a conversion tank, wherein the conversion tank transforms the chilled gas into a liquid fuel.

5. The method according to claim 4, wherein the electrolysis process further produces a steam; the steam is introduced in a distiller to generate distilled water.

6. The method according to claim 4, wherein the method produces table salt as a by-product.

7. A liquid fuel generating system comprising in combination:
(a) an electrolysis tank adapted for converting graphite into a gas by an electrolysis process under seawater;
(b) a line connected to the electrolysis tank to transport the gas;
(c) an air compressor connected to the line to receive the gas, the compressor adapted to increase the gas pressure and temperature;
(d) a heat exchanger unit connected to the air compressor, the heat exchanger adapted to reduce the temperature of the gas received from the air compressor;
(e) at least one expansion engine connected to the heat exchanger; the expansion engine adapted to drastically reduce the temperature of the gas and produce a chilled gas; and
(f) a conversion tank connected to the expansion engine;
the conversion tank adapted to transform the chilled gas into a liquid fuel via an expansion valve.

8. A power generating system comprising:
(a) an electrolysis tank adapted to convert graphite into a gas by an electrolysis process under seawater;
(b) a line connected to the electrolysis tank adapted to transport the gas;
(c) a gas turbine connected to the line adapted to receive the gas and spin and turn a generator;
wherein the generator produces all the electrical power needed to maintain the system and also supply additional electrical power.
